(19) United States
(12) Patent Application Publication
(10) Pub. No.: US 2025/0034716 A1
(43) Pub. Date: Jan. 30, 2025

(54) Device for Printing to a Recording Medium

(71) Applicant: Canon Production Printing Holding B.V., Venlo (NL)

(72) Inventors: Herbert Heimpoldinger, Ampfing (DE); Mehrad Biglari, München (DE); Christian Maier, Feldkirchen (DE)

(21) Appl. No.: 18/717,224

(22) PCT Filed: Dec. 5, 2022
(86) PCT No.: PCT/EP2022/084420

§ 371 Date: Jun. 6, 2024

(30) Foreign Application Priority Data
Dec. 6, 2021 (DE) 10 2021 132 015.1

(51) Int. Cl. C23C 18/16; B41J 13/076; C23C 18/18; C23C 18/32; C23C 18/42

(52) U.S. Cl. CPC C23C 18/1651; B41J 13/076; C23C 18/1841; C23C 18/32; C23C 18/42

(57) ABSTRACT

Provided is a device for printing to a recording medium, as well as a device for turning a recording medium, respectively include a transport roller that includes a base body on the surface shell of which a protective layer is formed. The protective layer includes at least one ruthenium layer. A method for producing a protective layer on a portion of the surface of the base body of a transport roller includes at least the application of a ruthenium layer onto the base body.

### CROSS-REFERENCE TO RELATED APPLICATIONS

This application is the United States national phase of International Patent Application No. PCT/EP2022/084420 filed Dec. 5, 2022, and claims priority to German Patent Application No. 10 2021 132 015.1 filed Dec. 6, 2021, the disclosures of which are hereby incorporated by reference in their entireties.

### BACKGROUND OF THE INVENTION

### Field of the Invention

The invention relates to a device for printing to a recording medium, which device comprises a transport roller. The transport roller has a base body on the surface shell of which a protective layer is formed. The invention also relates to a device for turning a recording medium, and a method for producing a protective layer on a portion of the surface of the base body of the transport roller.

### Description of Related Art

From the published patent application DE 10 2020 120 412 A1, a heating element is known that is part of a drying or fixing unit. The fixing unit is downstream of a printing station in order to dry the ink of the print image and fix it on the paper.

From the document U.S. Pat. No. 4,146,659 A, a heating roller is known for a fixing unit of an electrophotographic printer, said heating roller having a plating that can comprise ruthenium. This roller serves as a fixing roller in order to press the toner onto the paper.

Ruthenium platings are thus known only the prior art only given heated elements.

Coatings of silicone or Teflon for rollers or other guide elements are also known in printing or copying.

Given known inkjet printing systems, the recording medium is initially printed to with a print image on one side with the aid of a first printing unit. The ink applied onto the recording medium to generate the print image is dried with the aid of a drying unit. The recording medium is subsequently turned with the aid of a turning station, so that the recording medium supplied to a second printing unit is printed to with a second print image on the back side. The recording medium is subsequently supplied to a second drying unit that dries the ink of the print image printed on the back side.

The turning station turns the recording medium so that the unprinted back side is subsequently facing toward the second printing unit. Two identical printing units can hereby be used, whereby a cost-effective configuration of the printing system is possible. Due to the turning of the recording medium, the front side of the recording medium that is printed to with the first print image comes into contact with rollers of the turning station and/or rollers of the subsequent printing unit, in particular also in a loop puller arranged between the printing units. In such a loop puller, the recording medium is pressed with a relatively large force against the rollers of the loop puller, wherein a smearing of the ink of the first print image and/or an adhesion of ink of the first print image on the roller surface can occur.

### SUMMARY OF THE INVENTION

It is the object of the invention to specify a device for printing to a recording medium to avoid fouling of the surface of a roller for guiding the recording medium after printing to the recording medium with the aid of an inkjet printing unit and the drying of the print image such that the print image is not negatively affected. A turning unit as well as a method for producing a protective plating on the base body of a transport roller are also to be specified.

This object is achieved via a device having the features as described herein. Furthermore, the object is achieved via a device for turning a recording medium having the features as described herein, and via the method having the features as described herein. Advantageous developments are specified as described herein.

By providing a protective plating on the surface shell of the base body of the roller, said plating comprising at least one ruthenium layer, similar advantageous triboelectric properties are achieved as given a hard chrome layer, meaning that only slight friction occurs between the protective plating and the recording medium. Furthermore, the ruthenium layer is significantly more insensitive to adhering ink particles than the hard chrome layer. Via the protective plating, it is also achieved that the print image that is printed and dried on the recording medium is not negatively affected, in particular is not mackled, if the ink has not yet completely dried.

The recording medium is preferably a recording medium in the form of a web, which is also referred to as a continuous recording medium. The transport roller can be a driven or free-running transport roller. The base body on the surface shell of which the protective plating is formed can be made of aluminum, copper, iron, steel, stainless steel, aluminum alloys, copper alloys, iron alloys, and/or steel alloys.

Since ink particles adhering to the surface of a transport roller impair the quality of further print images, the device also leads to an improved print quality. The transport roller with the protective layer formed according to the invention is arranged downstream of a first printing unit and a first drying unit, since there the print image of the recording medium first comes into contact with the surface of the transport roller. In particular, the transport roller is a component of a turning unit for turning the recording medium, and/or a component of a subsequent second printing unit.

A second aspect of the invention relates to a device for turning a recording medium, having at least one transport roller according to the invention.

A third and fourth aspect respectively relate to a method for producing a protective plating on the surface shell of a transport roller for transporting a recording medium, in particular for transporting a recording medium already printed to with a print image. Via the specified method, a protective plating that comprises at least one ruthenium layer is respectively generated on the surface shell of the base body of the transport roller. Similar advantageous triboelectric properties are thereby achieved as given a hard chrome layer, i.e. only a slight friction occurs between the protective plating and the recording medium. Additionally, the ruthenium layer is significantly insensitive to adhering ink particles. Given a protective plating with ruthenium, a long-term adhesion of ink particles on the protective plating is significantly reduced relative to other known protective coatings.

### BRIEF DESCRIPTION OF THE DRAWINGS

The terms FIG., FIGS., Figure, and Figures are used interchangeably in the specification to refer to the corresponding figures in the drawings.

Additional features and advantages of the invention result from the claims and the subsequent description of preferred embodiments that are described using the attached drawings. Individual features of the embodiments, and all combinations among them as well as in combination with individual features or feature groups of the preceding specification and/or in combination with individual features or feature groups of the claims in any manner with one another, are deemed to be disclosed.

Shown are:

FIG. 1 a schematic representation of an inkjet printing device according to a first embodiment,

FIG. 2 a detailed representation of a turning unit of the printing device according to FIG. 1,

FIG. 3 a schematic representation of an inkjet printing device according to a second embodiment,

FIG. 4 a schematic representation of a transport roller having a protective layer,

FIG. 5 the structure of the protective layer on a surface shell of the transport roller according to FIG. 4, and

FIG. 6 a workflow plan for generating the protective layer according to FIG. 5.

### DESCRIPTION OF THE INVENTION

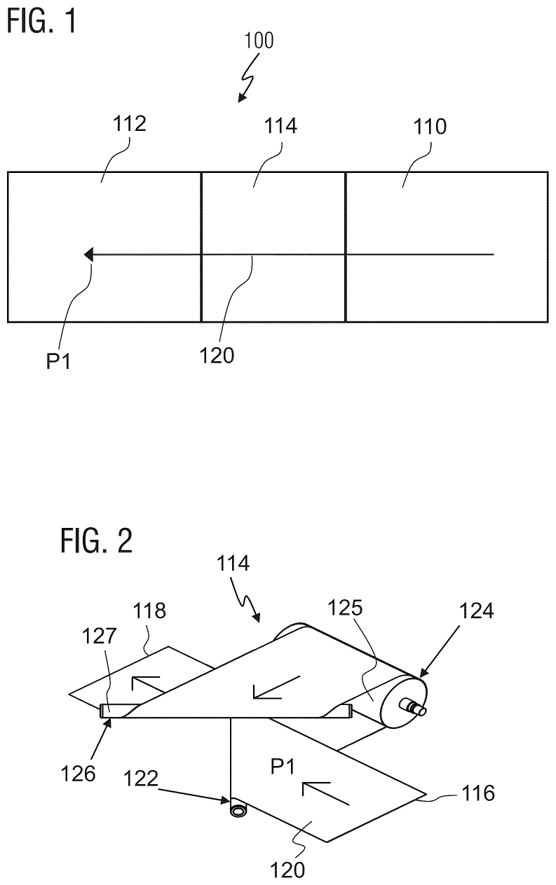

FIG. 1 shows a schematic representation of an inkjet printing device 100, according to a first embodiment, that is designed for printing onto a recording medium 120 in the form of a belt. The recording medium 120 can be produced from paper, paperboard, cardboard, metal, plastic, textiles, a combination thereof, and/or other materials that are suitable and can be printed to. The recording medium 120 is transported along the transport direction P1 (represented by an arrow) through the printing device 100. In other embodiments, the inkjet printing device is designed for printing to recording media 120 in the form of a sheet or page or plate.

The inkjet printing device 100 comprises a first inkjet printer 110 for printing to the front side of the recording medium 120, and a second inkjet printer 112 for printing to the back side of the recording medium 120. A turning unit 114 to turn the recording medium 120 is arranged between the inkjet printers 110 and 112. The recording medium 120 is supplied to the first inkjet printer 110 with the front side facing upward. After printing of a print image onto the front side by the first inkjet printer 110, the recording medium 120 is turned in the turning unit 114 so that the recording medium 120 is supplied to the second inkjet printer with the back side facing upward. The second inkjet printer 112 then prints a print image onto the back side of the recording medium. The inkjet printer 110, 112 can respectively print a single-color or multicolor print image onto the front side or back side of the recording medium 120. Such an arrangement of two structurally identical inkjet printers 110, 112 and a turning unit 114 arranged between said inkjet printers 110, 112, as shown in FIG. 1, is also referred to as a TWIN system.

The inkjet printers 110, 112 of the printing device 100 can respectively comprise a printing unit having at least two print bars, wherein each print bar can be used for printing with ink of a defined color, for example black, cyan, magenta, and/or yellow, and MICR ink if applicable. Different print bars can be used for printing with respective different inks. Furthermore, the inkjet printers 110, 112 respectively comprise at least drying unit that is configured and designed to dry a print image printed onto the recording medium 120 with the aid of the respective printing unit.

A print bar can comprise one or more print heads that are arranged in a plurality of rows side-by-side in order to print the dots of different columns of a print image onto the recording medium 120. In a concrete embodiment, a print bar comprises five print heads, wherein each print head prints the dots of a group of columns of a print image onto the recording medium 120. A print bar can thereby in particular comprise a number of print heads, in a range of from 5 to 20, in particular in a range of from 5 to 9.

Each print head of the printing unit comprises a plurality of nozzles, wherein each nozzle is configured to fire ink droplets onto the recording medium 120 or eject ink droplets in the direction of the recording medium 120. For example, a print head of the printing unit can comprise multiple thousands of effectively utilized nozzles that are arranged along a plurality of rows transverse to the transport direction P1 of the recording medium 120.

The printing device 100 also comprises at least one control unit, for example an activation hardware and/or a controller, that is configured to drive actuators of the individual nozzles of the individual print heads of the printing units in order to print the print image onto the front side or, respectively, onto the back side of the recording medium 120 depending on print data.

The drying unit of each inkjet printer 110, 112 is configured to dry the recording medium 120 after application of the ink by the one or more print bars. The drying unit can be controlled in this regard by the control unit of the printing device 100. For example, the drying can take place depending on the quantity of applied ink and/or depending on a type of the recording medium 120, in particular depending on absorption properties of the recording medium 120 being used.

FIG. 2 shows a detailed representation of the turning unit 114 according to FIG. 1. The recording medium 120 is output from the inkjet printer 110 with the front side facing upward and is supplied to the turning unit 114 at its input 116 with the front side that was printed to by the inkjet printer facing upward. At the output 118 of the turning unit 114, the recording medium 120 is output turned over, i.e. with the back side facing upward. The recording medium 120 is subsequently supplied to the input of the second inkjet printer 112.

As viewed in the transport direction P1 of the recording medium 120, the turning unit 114 has a first, slanted transport roller 122 that deflects the recording medium 120 by 90°. A second transport roller 124, serving as a deflection element which deflects the recording medium 120 by 180°, subsequently follows. From there, the recording medium 120 arrives at a second slanted transport roller 126 that deflects the recording medium 120 by 90°. The turned-over recording medium 120, thus with the back side facing upward, is then output at the output 118 of the turning unit 114. The recording medium 120 with the back side facing upward can subsequently be supplied to the second inkjet printer 112. The second inkjet printer 112 then prints a print image onto the back side of the recording medium 120. The surfaces of the transport rollers 126 and 124 contact the printed front side of the recording medium 120. In order to avoid ink deposits on the surface of the transport rollers 124, 126, and in order to avoid a negative effect on the print image on the front side due to ink transfer from the recording medium 120 onto the surface of the transport roller 124, 126, and/or a smearing of the print image on the front side of the recording medium 120, the transport rollers have a protective layer 125, 127.

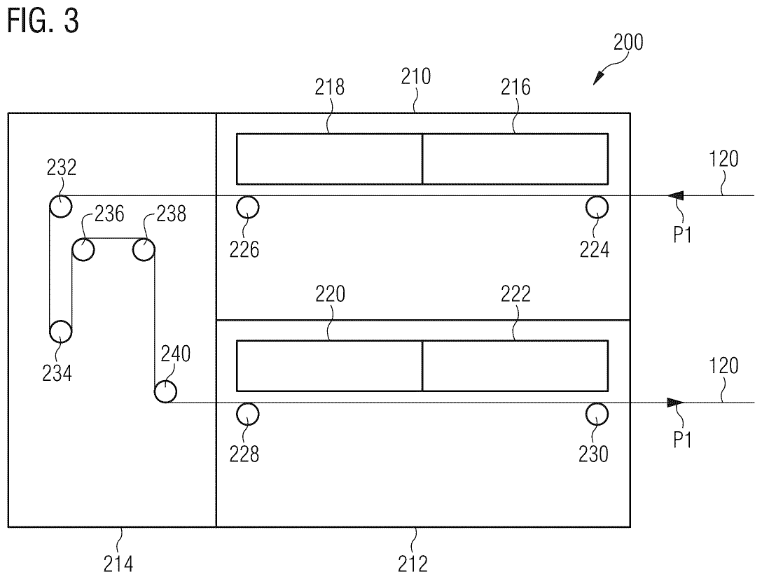

FIG. 3 shows a schematic representation of an inkjet printing device 200 according to a second embodiment. The inkjet printing device 200 is a duplex printer for printing to the front side and the back side of a recording medium 120 in the form of a web. In contrast to the printing device 100, the printing device 200 has a first printing module 210 for printing to the front side of the recording medium 120 with a print image, and a second printing module 212 for printing to the back side of the recording medium 120 with a print image. Elements having the same design and/or the same function have the same reference character.

The recording medium 120 in the form of a web is transported through the printing device 200 along a paper path, in the transport direction of the arrows P1. In the transport direction P1 of the recording medium 120, a turning unit 214 is arranged after the first printing module 210 and before the second printing module 212.

The printing modules 210, 212 respectively have a printing unit 216, 220 and a drying unit 218, 222 for drying the print image printed onto the recording medium 120 with the aid of the respective printing unit 216, 220. The design and the function of the printing units 216, 220, and of the drying units 218, 222, coincides with the printing units or, respectively, the drying units of the printers 110, 112. In the second embodiment, similar to as in the first embodiment, at least one control unit is provided for controlling the printing modules 210, 212 and the turning unit 214, as well as possible additional units.

For transporting and guiding the recording medium 120, the first printing module 210 has at least two transport rollers 224, 226, and the second printing module 212 likewise has two transport rollers 228, 230.

The first printing module 210 guides the recording medium 120, with its printed front side facing upward, to the turning unit 214. In the turning unit 214, the recording medium 120 is then turned and output, with its front side facing downward and the back side facing upward, to the second printing module 212, since then a second print image is printed onto the back side of the recording medium 120.

The turning unit 214 comprises 5 transport rollers 232 through 240. The transport rollers 232, 234, and 236 contact the back side of the recording medium 120. The transport rollers 236 and 238 contact the front side of the recording medium 120, which has been printed to by the printing unit 216 of the first printing module 210. The transport rollers 228 and 230 of the second printing unit 212 also contact the front side of the recording medium 120, which front side has already been printed to by the printing unit 216 of the first printing module 210. In order to avoid ink deposits on the surface of the transport rollers 228, 230, 232, 234, and 236, and in order to avoid a negative effect on the print image on the front side due to ink transfer from the recording medium 120 onto the surface of the transport roller 228, 230, 232, 234, and 236, and/or a mackling of the print image on the front side of the recording medium 120, the transport rollers 228, 230, 232, 234, and 236 have a protective layer formed as a protective plating.

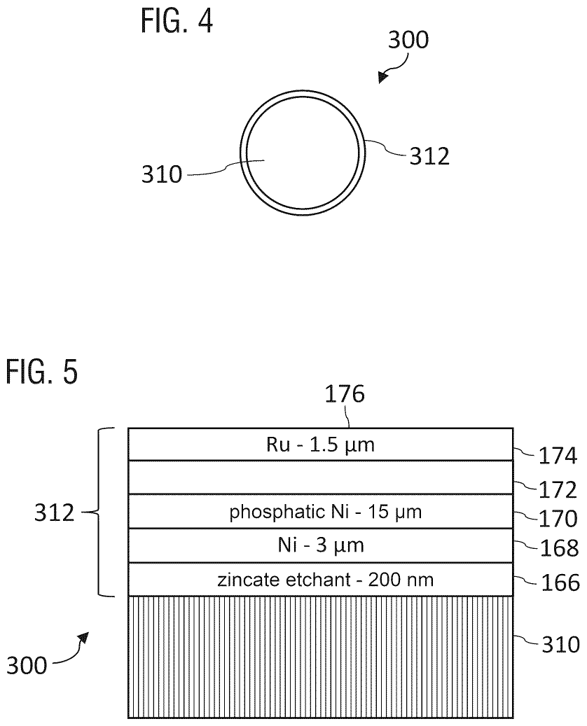

FIG. 4 shows a schematic representation of a transport roller 300 having a base body 310 and a protective layer 312. The transport roller 300 can in particular be used as a transport roller 228, 230, 232, 234, and 236 in the printing devices 100 and 200. Via the protective layer 312, the transport roller 300 can directly contact a print image printed onto a recording medium 120 with the aid of an inkjet printing unit and dried with the aid of a drying unit, without a negative effect on the print image taking place due to an ink transfer from the recording medium 120 to the protective layer 312 of the transport roller 300, and/or a mackling of the print image on the front side of the recording medium 120 taking place. The protective layer 312 comprises at least one ruthenium layer.

FIG. 5 shows an example of the structure of the protective layer 312 of a surface, i.e. on the surface shell, of the transport roller 300 according to FIG. 4. The base body 310 is made of aluminum in the present exemplary embodiment.

In other embodiments, the base body 310 can also be made of an aluminum alloy, copper, a copper alloy, iron, steel, stainless steel, an iron alloy, and/or a steel alloy, or can at least comprise at least one of these materials. The base body 310 is borne so as to be rotatable in a suitable manner, and can optionally be driven with the aid of a drive unit. The base body 310 has a circular outer diameter and can be made of solid material, at least in a partial region, or be of tubular design.

In the present exemplary embodiment, a zincate etchant layer 166 is generated with the aid of a chemical deposition on the surface shell of the base body 310, said surface shell being made of aluminum. The surface on which the zincate etchant layer 166 is applied can be suitably pre-treated beforehand, in particular can be blasted with a suitable abrasive. A suitable abrasive is, for example, special fused alumina with a grain size of 200 μm to 240 μm. For example, special fused alumina with a grain size of 220 μm can be used. Other suitable cleaning and/or pre-treatment methods can be additionally or alternatively executed.

After applying the zincate etchant layer 166, a nickel sulfamate layer 168 is generated via chemical and/or galvanic deposition. A phosphatic nickel layer 170 is subsequently applied via chemical deposition onto the nickel layer 168. A palladium layer 172 is applied via chemical deposition onto the phosphatic nickel layer 170, and the ruthenium layer 174 is applied via chemical deposition onto the palladium layer 172. The ruthenium layer 174 forms the surface 176 of the transport roller which is contacted by the printed side of the recording medium 120. Via the layer structure of the zincate etchant layer 166, the nickel layer 168, the phosphatic nickel layer 170, the palladium layer 172, and the ruthenium layer 174, a five-layer system is proposed that has at least similarly good triboelectric properties as a hard chrome layer. The triboelectric properties in particular relate to the occurring friction between the recording medium 120 and the transport roller 310, as well as the wear behavior of the protective layer 312 and the corrosion or corrosion susceptibility of the protective layer 312.

The chemical deposition takes place by introducing the base body 310 into a chemical bath. The chemical deposition is therefore referred to as a chemical bath deposition. The deposition of thin layers of a desired substance onto the base body 310 takes place via reaction of the ions and via clustering of colloidal particles. The chemical bath deposition is especially cost-effective, since no expensive plant engineering is required.

Alternatively or additionally, individual layers 166 through 174 can be produced via galvanic methods or via electrolysis. Given galvanic methods, the base body 310 serves in particular as a cathode on which the desired substance is taken up from an electrolytic bath. The metal that should be applied is typically located at the positive terminal, or the anode, and the object to be plated is typically located at the negative terminal, i.e. at the cathode. Given galvanic methods, an electrochemical deposition of metallic precipitates takes place, so that coats or layers can be applied onto the base body 310. For this purpose, the base body 310 to be coated is introduced into an electrolytic bath. In the present exemplary embodiment, the zincate etchant layer 166 has a layer thickness of 200 nm, the nickel layer 168 has a layer thickness of 3 μm, the phosphatic nickel layer 170 has a layer thickness of 15 μm, the palladium layer 172 has a layer thickness of 0.5 μm, and the ruthenium layer 174 has a layer thickness of 1.5 μm.

Relative to the hard chromium plating of the transport roller 310, the ruthenium layer 174 or, respectively, the proposed layer structure of the protective layer 312 has the advantage that no chromic acid is required to produce the protective layer 312, so that the environment is hereby protected and in particular the high disposal cost to dispose of chromic acid is avoided.

The zincate etchant layer 166 is in particular generated via chemical deposition in a zincate etchant bath, wherein the bath temperature preferably has a value in a range of from 10° C. to 25° C., and/or the treatment duration in the bath preferably lies within a range of 60 s to 120 s. A chemical deposition in a nickel sulfamate bath takes place to generate the nickel layer 168 on the base body 310, wherein the bath temperature of the nickel sulfamate bath preferably has a value in a range of from 30° C. to 50° C. The pH value of the nickel sulfamate bath is preferably within a range of from 3 to 4. The generation of the phosphatic nickel layer 170 takes place via chemical deposition in a bath with phosphatic nickel, wherein the bath temperature preferably has a value in a range of from 80° C. to 95° C. The phosphate content is preferably within a range of from 5% to 50%, in particular in a range of from 7% to 11%. High-phosphate nickel is also discussed here.

The palladium layer 172 is generated by chemical deposition in a palladium bath, wherein the bath temperature preferably has a value in a range of from 30° C. to 50° C. The pH value of the palladium bath is preferably in a range of from 7 to 9. The ruthenium layer 174 is generated via chemical deposition in a ruthenium bath, wherein the bath temperature preferably has a value in a range of from 40° C. to 70° C. The pH value of the ruthenium bath is preferably within a range of from 0.1 to 2, in particular within a range of between 0.9 and 2.

Alternatively, the zincate etchant layer 166, the nickel layer 168, the phosphatic nickel layer 170, the palladium layer 172, and/or the ruthenium layer 174 are generated via galvanic methods, wherein a maximum amperage to generate the palladium layer in a galvanic bath is preferably generated within a range of from 0.3 A/dm² to 1.5 A/dm² of cathode surface if the base body 310 forms the cathode. To generate the ruthenium layer in a galvanic bath, a maximum amperage in a range of from 0.3 A/dm² to 2.5 A/dm² of cathode surface is generated, wherein the base body 310 forms the cathode.

As an alternative to the aforementioned layer thicknesses, the zincate etchant layer 166 can have a thickness in a range of from 100 nm to 300 nm. The generated nickel layer 168 can have a layer thickness in a range of from 2 μm to 4 μm. The phosphatic nickel layer 170 can have a layer thickness in a range of from 10 μm to 20 μm. The palladium layer 172 can have a layer thickness of from 0.1 μm to 0.6 μm. The generated ruthenium layer can have a layer thickness in a range of from 0.3 μm to 2 μm, in particular in a range of from 0.1 μm to 0.8 μm, or in a range of from 0.8 μm to 1.5 μm.

The palladium layer 172 serves in particular as a corrosion protective layer. The nickel layer 168 is preferably highly corrosion-resistant and forms a sealed layer on the zincate etchant layer 166.

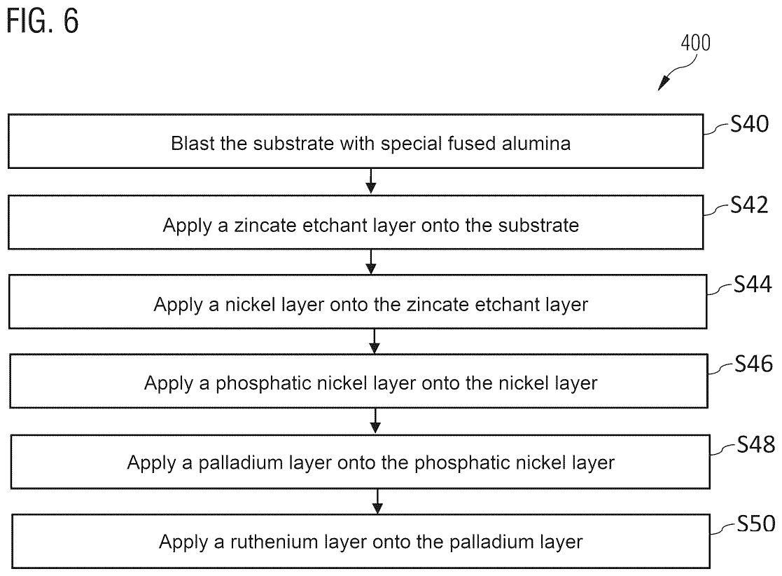

FIG. 6 shows a workflow plan 400 for generating the protective layer 312 according to FIG. 5. In a first step S40, the base body 310 is blasted with special fused alumina. In other embodiments, the base body 310 can be pre-treated in other suitable ways. In particular, other types of alumina and other grain sizes can be used. A chemical pre-treatment is also possible. In the present instance, special fused alumina with a grain size of 220 μm is used for blasting the base body 310.

In the next step S42, the zincate etchant layer 166 is subsequently applied onto the base body 310 via chemical deposition in a zincate etchant bath. In step S44, a nickel layer 168 is subsequently applied electrolytically onto the zincate etchant layer 166 in a nickel sulfamate bath. In step S46, a phosphatic nickel layer 170 is then applied onto the nickel layer 168 via chemical deposition in a bath. In step S48, a palladium layer 172 is then applied onto the phosphatic nickel layer 170 via chemical deposition in a palladium bath. In step S50, the ruthenium layer 174 is then subsequently generated on the palladium layer 172 via chemical deposition in a ruthenium bath. The ruthenium layer 174 then forms the outer surface of the protective layer 312 for contact with the recording medium 120.

By using base bodies 310 of transport rollers 300 that are plated with ruthenium, a contamination of the roller surface 176 with ink and/or dirt is reliably avoided. In order to ensure that, in a simple plating method the base body 310 is initially sand-blasted with special fused alumina, which leads to an increase in the surface roughness and simultaneously smooths possibly present rough peaks of the surface of the base body 310. A uniformly rough surface, without sharp or pointed edges, results via the use of special fused alumina. The base body 310 that is pre-treated in such a manner is subsequently coated with a thin ruthenium layer. This ruthenium layer has very good anti-adhesive properties and a high hardness. Via the purposeful surface treatment and the ruthenium plating, the achieved results are better than given transport rollers with a Teflon coating.

Teflon is a relatively soft material, which is why the transport rollers with a Teflon coating wear after a certain amount of time and entirely lose their anti-adhesive properties. The Teflon-coated rollers are thus not wear-resistant, and must be regularly swapped out of service. Depending on the recording medium 120 that is used, or depending on the type of paper to be printed to, these may wear sooner or later, which is why the risk of producing spoilage also exists for the user of the printing device 100, 200. The ruthenium-plated transport rollers 300 are wear-free and can be used over the entire service life of the printer or of the printing device 100, 200. Ruthenium-plated transport or deflection rollers 300 are not only markedly more advantageous to manufacture, but also contribute to a marked reduction of service costs and to process stability for the user due to freedom from wear.

### REFERENCE LIST

100, 200 inkjet printing device
110, 112 inkjet printer
114, 214 turning unit
116 input
118 output
120 recording medium
122, 124, 126,
224-240, 300 transport roller
125, 127 protective layer
210, 212 printing module
216, 220 printing unit
218, 222 drying unit
166 zincate etchant
168 nickel layer
170 phosphatic nickel layer
172 palladium layer
174 ruthenium layer
176 surface
310 base body
312 protective layer
400 workflow
S40-S50 method steps
P1 transport direction of the recording medium

1. A transport roller for transporting a recording medium,
the transport roller comprising:
a base body; and
a protective layer formed, on at least a portion of a surface shell of the base body,
wherein the protective layer comprises at least one ruthenium layer, and
wherein the protective layer comprises at least one zincate layer that is arranged between the ruthenium layer and the base body.

2. The transport roller according to claim 1, wherein the transport roller contacts the side of the recording medium on which the dried print image is located.

3. The transport roller according to claim 1, wherein the protective layer directly contacts the recording medium.

4. A method for producing a protective layer on a portion of a surface of a base body of a transport roller for transporting the recording medium, the transport roller being arranged downstream of a drying unit for drying an inkjet print image printed onto the recording medium,
and, a protective layer that comprises at least one ruthenium layer is generated on the portion of the surface of the base body of the transport roller, the method comprising:
blasting the base body with alumina before an application of the ruthenium layer or another layer,
and, before the application of the ruthenium layer or another layer, and after the blasting with alumina, the base body is treated via a chemical deposition in a zincate etchant bath, or is treated via a galvanic method, to generate a zincate etchant layer.

5. The method according to claim 4, wherein the temperature of the zincate etchant bath has a value in a range of from 10° C. to 25° C., and/or the treatment duration in the bath is within a range of from 60 s to 120 s.

6. The method according to claim 4, wherein, after the generation of the zincate etchant layer, the base body is treated via a chemical deposition in a nickel sulfamate bath, or is treated via a galvanic method, to generate a nickel layer.

7. The method according to claim 6, wherein the temperature of the nickel sulfamate bath has a value in a range of from 30° C. to 50° C., and/or the pH value is within a range of from 3 to 4.

8. The method according to claim 6, wherein the nickel layer is generated in a galvanic bath, a maximum amperage in a range of from 0.3 A/dm² to 2.5 A/dm² of a cathode surface is generated in the galvanic bath, and wherein the base body forms a cathode.

9. The method according to claim 6, wherein, after generation of the nickel layer, the base body is treated via a chemical deposition in a bath with phosphatic nickel, or is treated via a galvanic method, to generate a phosphatic nickel layer.

10. The method according to claim 9, wherein the temperature of the bath with phosphatic nickel has a value in a range of from 80° C. to 95° C., and/or the phosphate content lies within a range of from 5% to 50%.

11. The method according to claim 9, wherein, after the generation of the phosphatic nickel layer, the base body is treated via a chemical deposition in a palladium bath, or is treated via a galvanic method, to generate a palladium layer.

12. The method according to claim 11, wherein the temperature of the palladium bath has a value in a range of from 30° C. to 50° C., and/or the pH value lies within a range of from 7 to 9.

13. The method according to claim 11, wherein, after the generation of the palladium layer, the base body is treated via a chemical deposition in a ruthenium bath, or is treated via a galvanic method, to generate the ruthenium layer.

14. The method according to claim 13, wherein the temperature of the ruthenium bath has a value in a range of from 40° C. to 70° C., and/or the pH value lies within a range of from 0.1 to 2.

15. The method according to claim 13, wherein the ruthenium layer is generated in a galvanic bath, wherein a maximum amperage in a range of from 0.3 A to 1.5 A/dm² of a cathode surface is generated in the galvanic bath, and wherein the base body forms a cathode.

16. The method according to claim 13, wherein at least one of: the generated zincate etchant layer has a thickness in a range of from 100 to 300 nm,
the generated nickel layer has a thickness in a range of from 2 μm to 4 μm,
the generated phosphatic nickel layer has a thickness in a range of from 10 μm to 20 μm,
the generated palladium layer has a thickness in a range of from 0.1μ m to 0.6 μm,
the generated ruthenium layer has a thickness in a range of from 0.3 μm to 2 μm, or any combination thereof.

17. The method according to claim 4, wherein the alumina has a grain size of 200 μm to 240 μm.

18. The method according to claim 4, wherein the alumina is special fused alumina.
